(19) United States
(12) Patent Application Publication
(10) Pub. No.: US 2019/0102348 A1
(43) Pub. Date: Apr. 4, 2019

(54) Page Resource Placement Method and Apparatus

(71) Applicant: Alibaba Group Holding Limited, Grand Cayman (KY)

(72) Inventor: Jian Shen, Hangzhou (CN)

(21) Appl. No.: 16/144,299

(22) Filed: Sep. 27, 2018

Related U.S. Application Data
(63) Continuation of application No. PCT/CN2017/077453, filed on Mar. 21, 2017.

(30) Foreign Application Priority Data
Mar. 30, 2016 (CN) 201610194799.1

(51) Int. Cl. G06F 16/958; G06F 16/957; G06F 16/2457; G06F 16/2458; G06F 16/84

(52) U.S. Cl. CPC G06F 16/958; G06F 16/9577; G06F 16/86; G06F 16/2462; G06F 16/24578

(57) ABSTRACT

A method and an apparatus for page resource placement are disclosed. The method includes receiving a resource placement request, the placement request including resource location configuration information in a page, wherein the page includes at least one resource location, each resource location includes multiple unit display positions, each unit display position is used for displaying information of a service object, and a same resource location is used for displaying information of multiple service objects that satisfy a same placement condition; determining placement conditions corresponding to the resource location; and generating a page resource placement task, the placement task being used for recording a binding relationship between the resource location in the page and the placement conditions, to enable performing information placement for corresponding resource locations in the page according to the placement task. The efficiency of page resource placement can be improved through the embodiments of the present application.

### CROSS REFERENCE TO RELATED PATENT APPLICATIONS

This application claims priority to and is a continuation of PCT Patent Application No. PCT/CN2017/077453 filed on 21 Mar. 2017, and is related to and claims priority to Chinese Patent Application No. 201610194799.1, filed on 30 Mar. 2016, entitled “Page Resource Placement Method and Apparatus,” which are hereby incorporated by reference in their entirety.

### TECHNICAL FIELD

The present application relates to the technical field of page placement processing, and particularly to page resource placement methods and apparatuses.

### BACKGROUND

In an e-commerce transaction platform system, clients are usually needed to provide various types of front-end pages to users. For example, a Tmall homepage can be provided in Tmall Mall system, and various types of topics, channels, etc. are usually provided on the homepage. Examples are a “Fashion Tmall” channel used for displaying various types of fashion brand information, a “Meow Fresh” channel for displaying products such as fresh fruits, etc. Regardless of a homepage or various types of topics or channels, page generation usually needs to include three operations: page construction, page filling, and page placement.

Page construction refers to designing a plurality of resource locations in a page, with each resource location usually including a plurality of “pits”, which can define how many rows are displayed per screen, and how many pits are displayed in each row. Various pits in a resource location usually possess the same attributes, and therefore these pits can also be collectively referred to as a pit group. Furthermore, a framework of a front-end page can be constructed with an addition of a banner (including a banner of an advertisement, a title, etc.) or other components (a background color) required by the page. Subsequent page filling and page release refer to associating specific data with the resource places defined in the framework (e.g., a product name, a sales volume, a price, a discount, etc.).

For page filling, since displaying each block in the page needs to provide respective data content for corresponding resource locations, a process of filling the page is to determine data content corresponding to each resource location.

Page placement refers to placing the determined data content into specific resource locations and publishing, so that a user can access specific page content through a URL of the page.

In existing technologies, the process of page filling is usually performed manually. Specifically, the staff of a transaction platform needs to select specific data from a main product information database of the transaction platform. In other words, a manual method is needed to find a required product id from the product information database, and then obtain corresponding material such as a product title, an image address, a product details page link, etc., according to the id. The corresponding material is manually filled in or copied and pasted into a form such as Excel, and then filled into a system. The page can be finally placed according to the form, i.e., displaying specific data on a front-end page.

This type of manual selection is obviously inefficient, and information such as a sales volume and a price of each product tends to be changing constantly. When a certain product object is no longer suitable for display on a front-end page, an appropriate product object needs to be selected from the database again, and the Excel form as described above is manually modified. A process thereof requires a lot of labor costs.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The application provides a method and an apparatus for placing page resources, which can improve the processing efficiency of page resource placement.

This application provides the following solutions.

According to embodiments provided by the present application, the present application discloses the following technical effects:

Through the embodiments of the present application, after a basic page framework is set up, resource locations can be associated with specific placement conditions, and a system can generate a corresponding placement task, and automatically import data according to the placement task, and place the data to each unit display position in corresponding resource locations, thus completing the placement of page content and publishing the page. In other words, a page creator does not have to manually find eligible material in a data source and perform placement, thus improving the efficiency of placing page content.

Apparently, any product implementing the present application does not necessarily achieve all of the foregoing advantages at the same time.

### BRIEF DESCRIPTION OF THE DRAWINGS

In order to more clearly illustrate the embodiments of the present application or technical solutions in the existing technologies, drawings that are used in the embodiments are briefly described herein. Apparently, the drawings described herein merely represent some embodiments of the present application. Based on these drawings, one skilled in the art can obtain other drawings without any making any creative effort.

FIG. 1 is a flowchart of a first method provided by the embodiments of the present application.

FIG. 2 is a schematic diagram of a first interface provided by the embodiments of the present application.

FIG. 3 is a schematic diagram of a second interface provided by the embodiments of the present application.

FIG. 4 is a schematic diagram of a third interface provided by the embodiments of the present application.

FIG. 5 is a schematic diagram of a fourth interface provided by the embodiments of the present application.

FIG. 6 is a schematic diagram of a fifth interface provided by the embodiments of the present application.

FIG. 7 is a schematic diagram of a sixth interface provided by the embodiments of the present application.

FIG. 8 is a flowchart of a second method provided by the embodiments of the present application.

FIG. 9 is a flowchart of a third method provided by the embodiments of the present application.

FIG. 10 is a flowchart of a fourth method provided by the embodiments of the present application.

FIG. 11 is a flowchart of a fifth method provided by the embodiments of the present application.

FIG. 12 is a schematic diagram of a first apparatus provided by the embodiments of the present application.

FIG. 13 is a schematic diagram of a second apparatus provided by the embodiments of the present application.

FIG. 14 is a schematic diagram of a third apparatus provided by the embodiments of the present application.

FIG. 15 is a schematic diagram of a fourth apparatus provided by the embodiments of the present application.

FIG. 16 is a schematic diagram of a fifth apparatus provided by the embodiments of the present application.

### DETAILED DESCRIPTION

The technical solutions in the embodiments of the present application are clearly and completely described hereinafter with reference to the drawings in the embodiments of the present application. Apparently, the described embodiments represent only a part and not all of the embodiments of the present application. All other embodiments obtained by one of ordinary skill in the art based on the embodiments of the present application fall within the scope of protection of the present disclosure.

In the embodiments of the present application, in order to improve the efficiency of processing a page, a page designer can be provided with an automated resource placement system. Through this system, the designer only needs to specify a placement condition corresponding to a resource location. The system can then generate a corresponding placement task, automatically import and place data in each unit display position in the corresponding resource location according to the placement task, instead of manually selecting a specific placement element from a resource library, thereby improving the work efficiency. Specific implementations are described in detail hereinafter.

### First Embodiment

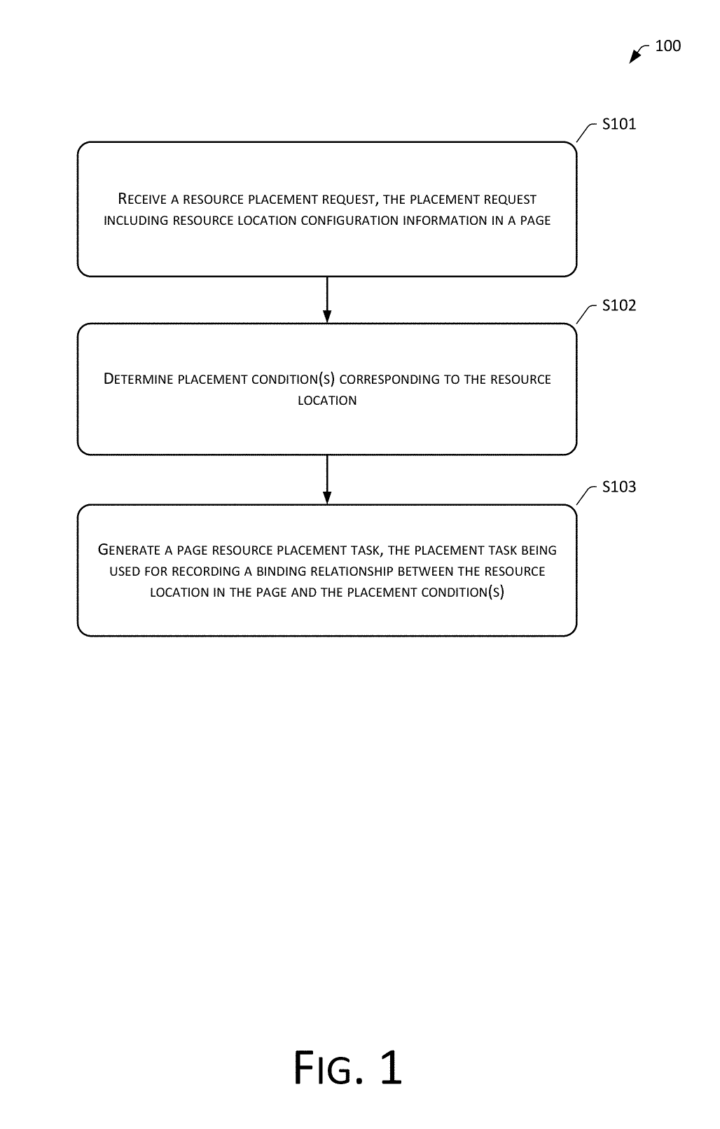

Referring to FIG. 1, a first embodiment of the present application provides a method 100 for placing a page resource. The method 100 may include the following operations.

S101: Receive a resource placement request, the placement request including resource location configuration information in a page, where the page includes at least one resource location, each resource location includes multiple unit display positions, each unit display position is used for displaying information of a service object, and a same resource location is used for displaying information of multiple service objects that satisfy a same placement condition.

The page may be a page framework established during a process of page construction, which includes defining at least one resource location. A resource location usually includes a plurality of unit display positions (also known as “pits”). Each unit display position is used for displaying information of a service object. The service object may include a product object, or may be a store of a first user (e.g., a selling user, a merchant, etc.), and the like. A same resource location is used for displaying information of multiple service objects that meet a same placement condition. For example, in a Tmall homepage, a resource location used for displaying a certain promotion activity may exist, in which 10 unit display positions used for displaying information about 10 product objects are provided. This means that these 10 product objects are all product objects that participate in the same promotion activity, and so on.

The resource location configuration information determined in this operation may include a name of a resource location, the number of unit display positions, a location, a manner of arrangement, and a manner of grouping. In addition, style information of the resource location may also be included, which includes an attribute field of a service object to be displayed in a unit display position. Examples may include a name, a picture, a link address, price information, a title, etc., of the service object. Apparently, for different pages and different resource locations, different style information may exist, which can be defined when a page framework is designed.

S102: Determine placement condition(s) corresponding to the resource location.

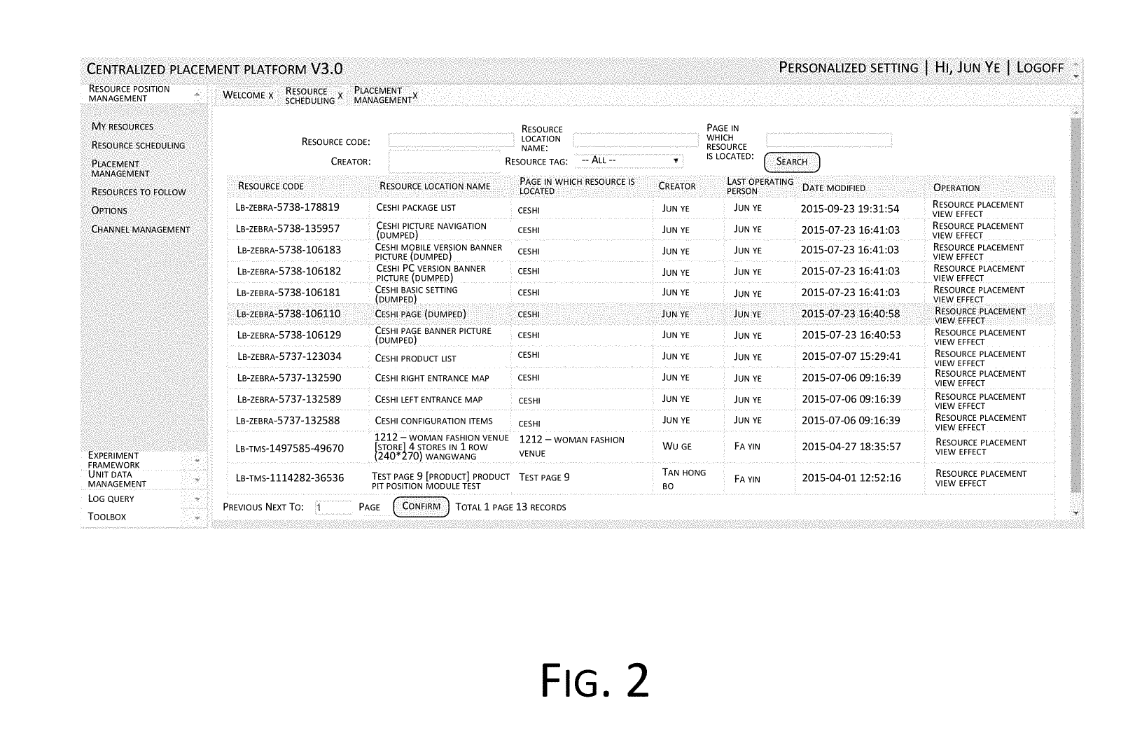

In implementations, a certain page is assumed to have determined resource locations which include a Ceshi package list, a Ceshi product list, a Ceshi right entrance map, a Ceshi left entrance map, etc. In order to facilitate resource allocation for these resource locations, an information list of the resource locations in the page may be provided. For example, an interface as shown in FIG. 2 displays content such as a name of each resource location included in a page, a page to which a resource location belongs, a date of modification, a creator, an operation, etc. After the process of page construction is completed, the system can determine the above information, and can provide resource location information to the page creator in an interface. Apparently, information such as the numbers, locations, manners of arrangement and manners of grouping of unit display positions, and attribute fields of service objects to be displayed in the unit display positions, may not be displayed to a page creator in an interface. However, the system may record these pieces of information in the backend for use in subsequent operations.

When information of a resource location is provided in the interface, an operation option may also be provided for configuring placement information for the resource locations. In implementations, a button such as “place resource” may be provided in an “operation” field as shown in FIG. 2, and the button is used for initiating an operation of resource placement. In other words, after a resource location information list is provided, if a page creator needs to perform resource placement to a certain resource location, he/she may click an operation option such as “place resource”. Since a “placement resource” button corresponds to a resource location identifier, the system can determine which resource location that the creator wants to allocate a resource after a certain “place resource” button is operated. After a specific placement condition is established, a relationship between a resource location identifier and the placement condition can be established, and a placement task can be generated.

In implementations, after a “place resource” button corresponding to a certain resource location is operated, a specific placement condition may be set from multiple aspects when placement conditions are determined. For example, an interface for selecting a dynamic data source may first be provided, and a selection result of a dynamic data source is then recorded and determined as a first condition to help determining candidate service object(s) to be served according to the first condition. For example, In implementations, various types of selectable dynamic data sources may be provided to a page creator for selection using a drop-down box or the like. The dynamic data source may include a data source of statistical information of service object(s). The statistical information may include sorting result information of service objects sorted according to preset indicators, sales ranking list data of a certain category of commodity objects, and the like, may also include information about correlation between service objects. For example, a certain electronic product may be determined to be related to some accessory product objects according to co-occurrence of commodity objects in transaction order(s), etc. This type of correlation information may also help with information placement.

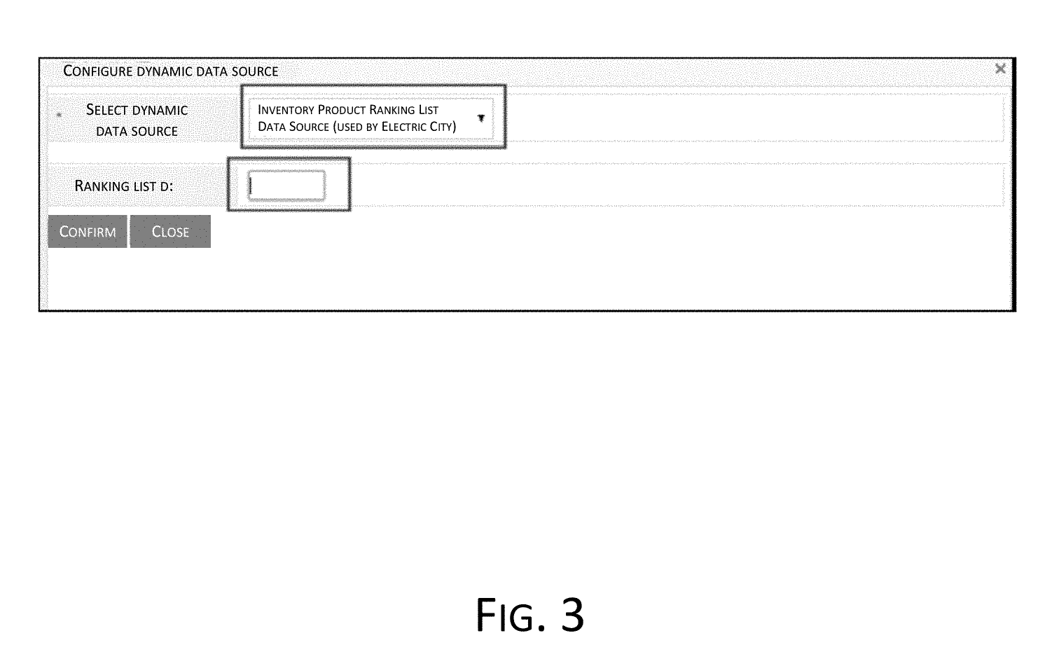

In implementations, in order to facilitate selection of a dynamic data source, an interface for selecting a dynamic data source may be provided. For example, as shown in FIG. 3, identification information such as a name of each dynamic data source may be provided through a drop-down list or the like. A page designer can select a desired dynamic data source from a drop-down menu by name. For example, a dynamic data source of “Inventory Product Ranking List Data Source (used by Electric City)”, etc., can be selected in an interface shown in FIG. 3. A dynamic data source may be statistically obtained by other service modules in an application. In other words, a dynamic data source may be directly obtained from other service modules according to the embodiments of the present application. The embodiments of the present application can create a data set corresponding to a resource location by directly using data in these types of existing data sources is created. As such, a specific unit display position in the resource location can use information in the data set to display the information.

After a dynamic data source is selected, some information such as ranking lists, for example, a sales ranking list of product objects in an industry, a popularity ranking list of merchants, etc., is included. Ranking information of multiple service objects is recorded, and is recorded by identification of the service objects such as names or ids. For example, information recorded in a certain data source for “Inventory Product Ranking List Data Source (used by Electric City)” can be represented in Table 1 below:

TABLE 1

| Serial number | Service object id |
|---|---|
| 1 | 100012 |
| 2 | 100036 |
| 3 | 100027 |
| . . . | . . . |

Therefore, after a dynamic data source is selected, some or all of service object identifiers therein can be extracted as candidate service objects that can be displayed in specific unit display positions of a resource location. When these candidate service objects are displayed in the specific unit display positions, the number of service objects included in a data set is usually larger than the number of service objects that need to be displayed in the resource location. For example, the resource location needs to display information of a total of 10 service objects, but information of 100 service objects may exist in the candidate service objects. Advantages thereof are as follows. On the one hand, service objects that satisfy a requirement in a better manner can be selected from the candidate service objects for display through subsequent product selection rules. On the other hand, although the number of unit display positions in the resource location is limited, a way of displaying in a rotating manner can normally be used to allow more service objects to have opportunities of being displayed. Therefore, redundant information in the set of candidate service objects can provide data support to displaying in a rotating manner.

In implementations, multiple types of implementations of selecting service objects from candidate service objects can exist. For example, selection may be performed in a random manner, or in a descending order of ranking, etc. Alternatively, in order to improve the effectiveness of displaying resources in a page, selection rule(s) can be configured when placement condition(s) is/are configured. In other words, when a placement condition corresponding to the resource location is determined, a selection rule may also be determined, and determined as a second condition, so that selection can be performed on the candidate service objects according to the second condition.

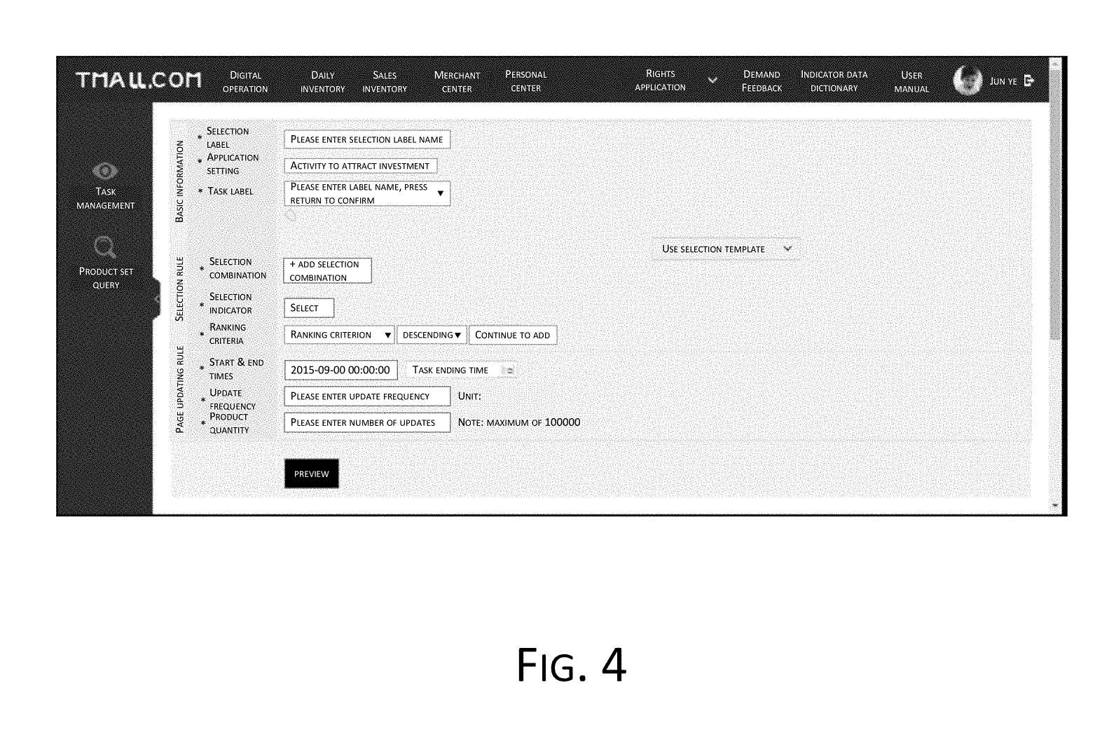

The selection rule may include one or more rules as follows: the number of service objects, screening condition information, ranking information, and the like. In implementations, a corresponding configuration interface for selection rules may be provided. For example, an interface as shown in FIG. 4 may be displayed, and a screening combination, a selection indicator, a ranking condition, the number of products, and the like, may be configured through the interface.

The selection indicator may be an indicator on which service objects are ranked, for example, may be ranked according to sales volumes, or ranked according to rates of good comments, and the like. The ranking condition may refer to a strategy of sorting among service objects, for example, arranged in a descending order, and the like. Combining the selection indicator with the ranking condition, a specific sorting strategy can be determined. For example, sorting is performed in order of a descending order of sales volumes.

The screening strategy refers to performing a further screening control of service objects from the set of candidate service objects. For example, a configuration may be such that products under a same brand or a same SPU (standardized product unit) do not appear repeatedly. Specifically, if a currently configured placement rule includes “select the top ten according to sales volumes of items”. However, an actual situation is that a product object 1 and a product object 2 both meet this rule, and these two product objects belong to a same brand. Alternatively, these two product objects belong to a same SPU, for example, being mobile phones of a certain model of a certain brand. An only difference therebetween is a difference in specifications (for example, one of them is white, the other is black, etc.). As such, only one of these two products can be set to appear in a same resource location, for example. In implementations, configuration can be performed through a screening strategy in a configuration interface for placement rules.

Apparently, in a real application, in order to further improve the efficiency of page resource placement, a rule template may be generated according to each rule that is set in a selection rule setting process. Identification such as a respective name of each rule template, and information such as an application setting of a rule template, may also be provided, and then added into a selection rule library. In this way, in a process of setting a selection rule, a list of names of various selectable rule templates can be provided according to the selection rule library, and information such as application settings of the rule templates can also be provided. As such, a designer can select an appropriate rule template based on information such as a name and an application setting of the rule template. In this way, it is not necessary to fill in selection rules item by item in an interface as shown in FIG. 4, and a configuration of selection rule(s) can be completed for a specific resource location. Through this type of approach, reuse of a selection rule template on different pages and different resource locations can be achieved, and the efficiency of page placement can be further improved.

After the first condition and the second condition are set, what service objects are displayed in the resource location can be determined, and a further configuration can be performed regarding what attribute information of the service objects is specifically displayed. In implementations, style information associated with a resource location is usually set when the resource location is created, which includes attribute(s) of a service object on which attribute field(s) is/are needed to be displayed in a particular unit display position. Therefore, at operation S101, attribute field(s) to be displayed in a unit display position can also be determined. Accordingly, when a placement condition corresponding to the resource location is determined, attribute field(s) to be displayed in a unit display position may also be determined as a third condition. As such, when placement is actually performed, attribute field(s) to be displayed for each service object can be determined according to the third condition. In this way, corresponding attribute value information can be extracted from a service object information database based on an identified identifier of a service object and an attribute field to be displayed. The service object information database is a basic information database maintained in a sales platform. For example, after a store of a merchant is created, basic information about the merchant, including an id, a name, and a link address, and a representative picture, etc., of the store may be added to a store information database. Similarly, when a product object is created, basic information about the product object, including an id, a name, a link address, a representative picture, a price, a title, and the like of the product object, is also added to a product object information database. In addition, when a store or a product object is involved in a certain activity, dynamic information such as a related event price and an event title is also stored in the service object information database. Therefore, through the service object information database, specific attribute values on attribute fields that are needed by a specific service object can be extracted.

It should be noted that, In implementations, a field name of the attribute field to be displayed that is set in a resource location may not be exactly the same as a field name of the corresponding attribute field in a service object database. For example, a corresponding field name of a “picture” of a certain resource object that needs to be displayed in a resource location in the service object information database may be “representative picture”, etc. Therefore, in order to facilitate a retrieval of an attribute value, a mapping relationship between attribute fields that need to be displayed and attribute fields in the service object information database may be pre-established. Based on the mapping relationship, specific attribute values on attribute fields that are needed are retrieved. For example, service objects to be displayed in a certain resource location are some product objects. Attribute fields that need to be displayed include a product object link address, a title, a product picture, a counter price, an activity price, an activity price title, and the like. In the product object information database, the corresponding attribute fields may be a link address, a title, a representative picture, an original price, an activity price, an activity price title, etc. Therefore, a mapping relationship that is established can be represented in Table 2 as follows:

TABLE 2

| Attribute fields needed to be | Attribute fields in product |
|---|---|
| displayed | object information database |
| Product object link address | Link address |
| Topic | Topic |
| Product picture | Representative picture |
| Counter price | Original price |
| Activity price | Activity price |
| Activity price title | Activity price title |
| . . . | . . . |

In this way, when extracting a specific attribute value from the service object information database, mapping between attribute field names may first be performed based on the foregoing mapping relationship, and then the specific attribute value is extracted from a mapped attribute field. Based on a result of the extracted attribute, a data set can be created, i.e., a corresponding data set can be created for each resource location in the page.

In a real application, in order to facilitate viewing, the attribute value information of each extracted service object on each required attribute field may be displayed in an interface, so that a designer can preview. Specifically, candidate service objects may be determined according to the first condition, and attribute value information of the candidate service objects on corresponding attribute fields are extracted from the service object information database according to the third condition, and then a specific preview interface is provided according to these pieces of information. It should be noted that the number of unit display positions included in a resource location of an actual page is usually limited, for example, five per line with a total of two lines, etc. Each unit display position is typically used for presenting information about a service object, and so the number of service objects that can be displayed within a resource location is also limited. When a data set is created, the number of service objects included in the data set may be greater than the number of unit display positions included in a resource location, so allow operations such screening and selection to filter out service object(s) that fail(s) to meet condition(s).

It should be noted that a designer can understand content of the service objects to be displayed more intuitively by providing the foregoing preview information. In addition, in practical applications, different pages and different resource locations may also have demands to use a same data set. Therefore, in the embodiments of the present application, in order to further increase a sales volume of the page, a data set may be generated according to attribute values of the candidate service objects on corresponding attribute fields, and the data set may be stored. A data set identifier may also be provided. In this way, when a new placement request is received at a later time, selectable data set identifier(s) is/are provided, and the data set identifier is determined as a fourth condition to enable determination of the data set according to the fourth condition. In other words, in a situation in which a data set is provided, selection of a dynamic data source and determination of attribute fields are not needed, and candidate service objects and specific attribute value information on some attribute fields can be obtained.

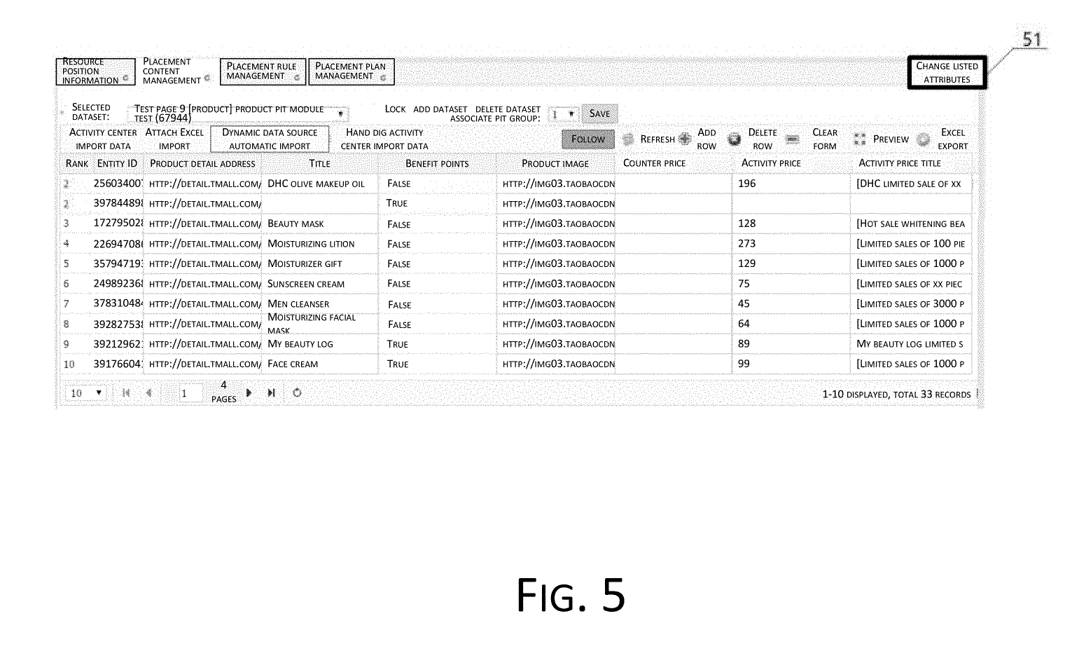

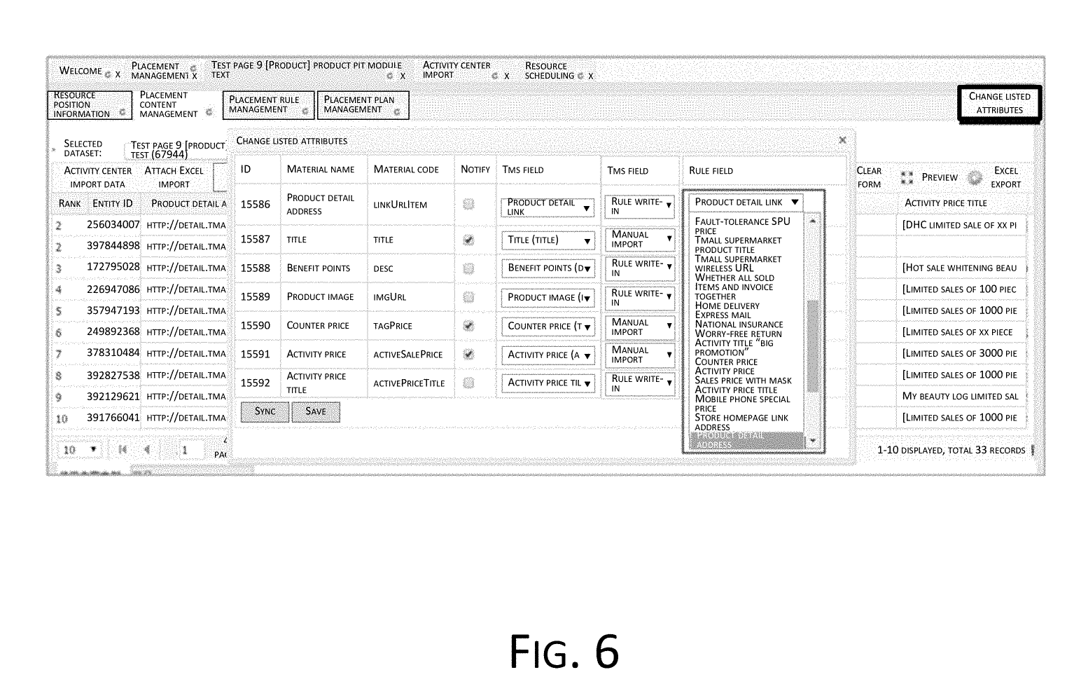

For example, as shown in FIG. 5, the interface is a data set preview interface displayed after a data set named “Test Page 9 [Commodity] Commodity Pit Module Test (67944)” is selected. In addition, in practical applications, attribute fields to be displayed can also be modified. Specifically, an operation option for modifying an attribute field may be provided in an interface that presents a data set, for example, a “revise attribute” button as shown in FIG. 5. After clicking the button, an interface such as the one shown in FIG. 6, may be displayed. Various attribute fields included in FIG. 5 can be displayed, and other selectable attribute fields can be provided for each attribute field respectively. For example, an attribute field of an original “commodity detail link address” in FIG. 6 can be modified to “fault-tolerant SPU price”, “Tmall supermarket product title”, and the like. Other attribute fields can be processed in a similar manner. In this way, after an attribute field is modified, attribute value information on the modified attribute field may be extracted from the service object information database according to the attribute field all over again, and configuration information of a corresponding data set is updated, so that subsequent data extraction and placement can be performed according to the updated configuration information when the data set is placed.

In implementations, when a placement condition is configured, a starting time and an ending time of placement may be configured and determined as a fifth condition in addition to configuring a dynamic data source, a selection rule, and an attribute field display rule. As such, a status of a placement task is determined based on the fifth condition, and the corresponding placement task is performed according to the status. The starting time and the ending time indicate that placement information associated with the resource location can be set to be valid for a certain period of time, for example, from April 1 to 7, etc. In this way, resource placement can be performed for the resource location according to the set placement condition during this time period, and other time periods are not valid.

In addition, since attributes of each material in the database may change over time. For example, a sales volume of each product object is constantly changing as a sales operation continues, and thus product objects corresponding to top ten rankings of sales volumes may also change. Therefore, in implementations, an update rule may also be configured for a resource location, which includes a cycle, a frequency, and the like, of an update. For example, an update is performed once after a task runs for one week, at 0:00 every day, etc. Update rule configuration information can be recorded in a placement task, As such, a specific data set associated with a resource location can be automatically updated according to an update policy. In addition, if a resource location has a requirement for displaying in a rotating manner, a mode of displaying in a rotating manner can also be configured in a placement rule, for example, a cycle of rotation of displaying, a loop condition, and the like. Information about a starting time and an ending time, configuration information of an update rule, and the like can be configured in a rule management interface shown in FIG. 3.

It should be noted that the page described in the embodiments of the present application may include a client home page provided by a transaction platform, an entry page of a promotion activity, and the like. Such type of page is usually designed by a technician on the platform side. A user of the page automatic placement system provided in the embodiments of the present application may include this type of page designer. Alternatively, in another application scenario, the page described in the embodiments of the present application may also refer to a store page of a first user. For example, some product objects of a certain first user are participated in a promotion activity, and these product objects may appear in public pages such as an activity portal page, and may also have a need to be displayed in a private page of the first user, such as a store page. A designer of this type of private page may typically be the first user. In other words, the first user can decide what content to be displayed in a store page thereof. For this type of situation, the first user can also use the page placement system provided by the embodiments of the present application to perform automatic placement. Details of a process of automatic placement are similar to the one for a homepage, an activity portal page, and the like, except that initiators of a placement request are different. Furthermore, for pages related to a store of the first user, dynamic data sources related to the first user may be provided by the server to a client of the first user, for example, in-store sales ranking list data of the first user, relevance information of service objects within the store, etc. In this way, it can be realized that the first user participating in a certain promotion activity can more conveniently place resources to his/her own store page, thereby achieving a purpose of maximizing a sales volume.

S103: Generate a page resource placement task, the placement task being used for recording a binding relationship between the resource location in the page and the placement condition(s), to enable performing information placement for corresponding resource locations in the page according to the placement task.

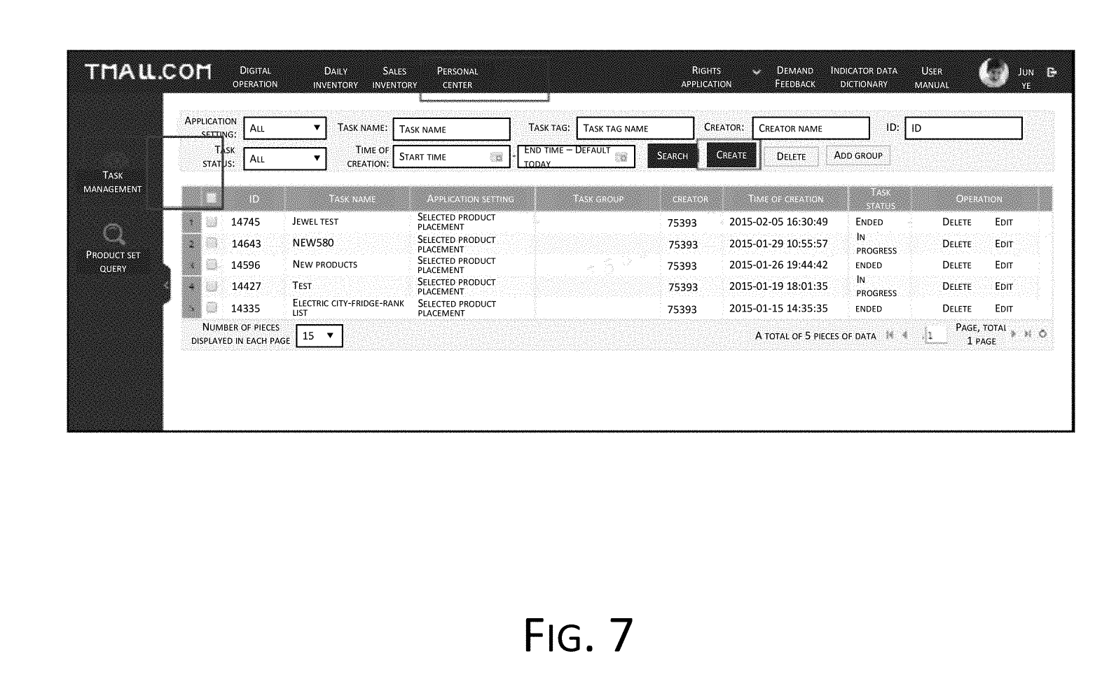

After the placement condition(s) corresponding to the resource location is/are determined through the foregoing operations, an association relationship between the selected resource location and the placement condition(s) can be established. For example, for a resource location of “Ceshi Commodity List”, a configured data set is a data set as shown in FIG. 5. A configured selection rule includes “Top 10 by sales volumes of single items”, etc. According to such association relationship, a placement task is then created and added into a placement task management list. FIG. 7 shows a placement task management interface, which includes multiple placement tasks. According to information such as starting and ending times of the placement tasks, state information of each placement task can also be determined, and can be classified as, for example, “in progress”, “completed”, etc. Further, corresponding resource data can be automatically placed to resource location(s) by performing a placement task corresponding to an “in progress” state.

In short, after a basic page framework is set up, the embodiments of the present application can associate a resource location with a specific placement condition. A system can generate a corresponding placement task, automatically import data according to the placement task, place corresponding data to each unit display position in the resource location to complete placement of content of a page, and publish the page. In other words, a page creator does not need to manually find materials that satisfy condition(s) in data sources and perform placement, thus improving the efficiency of placing page content.

### Second Embodiment

In the above first embodiment, a process of how to create a placement task is described in detail. After a placement task is created, information can be placed into specific resource location(s) in a specific page according to specific content in the placement task. This is described in detail as follows.

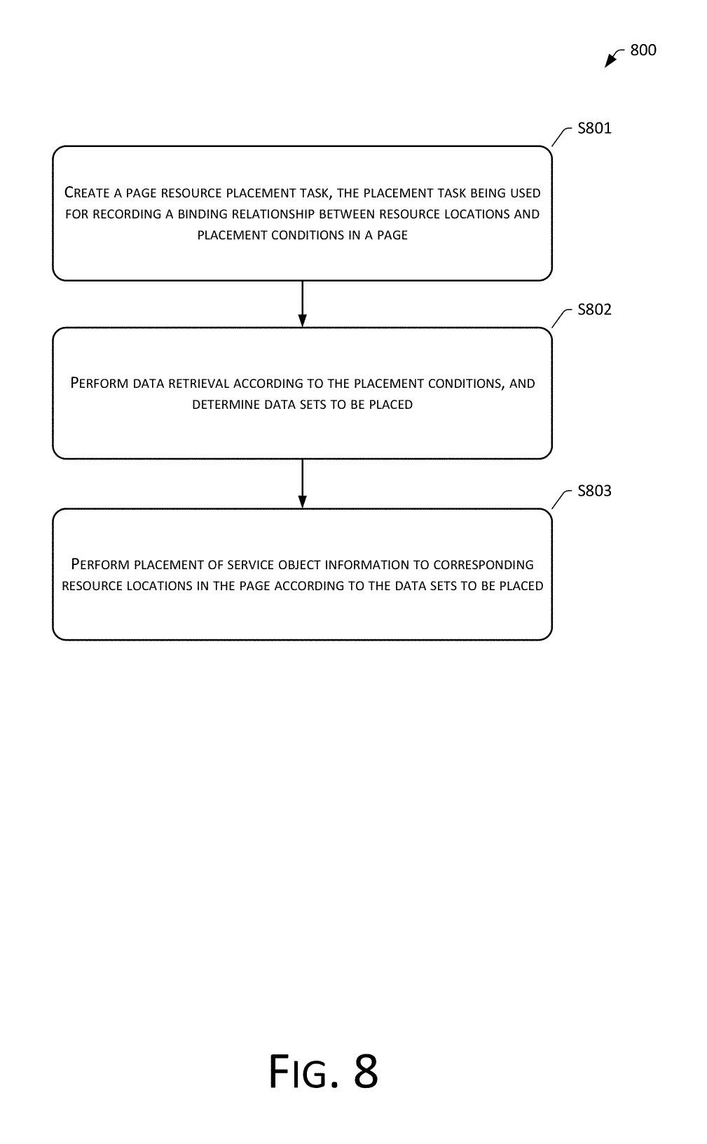

Referring to FIG. 8, the second embodiment provides a page resource placement method. The method 800 may include the following operations.

S801: Create a page resource placement task, the placement task being used for recording a binding relationship between resource locations and placement conditions in a page, where the page includes at least one resource location, each resource location includes a plurality of unit display positions, each unit display position is used for presenting information of a service object, and a same resource location is used for presenting information of multiple service objects that satisfy a same placement condition.

S802: Perform data retrieval according to the placement conditions, and determine data sets to be placed.

The placement conditions include a first condition, and target dynamic data source information is recorded in the first condition. In this case, identification information of candidate service objects may be determined based on the target dynamic data source information recorded in the first condition. Attribute information of the candidate service objects are then extracted from a service object information database based on the identification information of the candidate service objects, and data sets to be placed are determined based on the attribute information of the candidate service objects.

If the placement conditions further includes a second condition and selection rule information is recorded in the second condition, the candidate service objects may also be selected according to the second condition, and the data sets to be placed are then determined based on a result of selection.

If the placement conditions further includes a third condition and a service object attribute field to be displayed in each unit display position in the resource location is recorded in the third condition, attributes of the candidate service objects are extracted from a service object information database. Attribute value information of the candidate service objects on the corresponding attribute fields may be extracted from the service object information database according to the third condition.

In addition, if the placement conditions include a fourth condition and a data set identifier is recorded in the fourth condition, a data set to be placed may be directly determined according to the data set identifier in the fourth condition, without a need of further performing operations such as selection of a dynamic database, determination of attribute fields, and so on.

In addition, if the placement conditions further include a fifth condition and the fifth condition records placement starting and ending time information, a state of the placement task may also be determined according to the fifth condition. The corresponding placement task is then performed according to the state.

S803: Perform placement of service object information to corresponding resource locations in the page according to the data sets to be placed.

After determining the data sets to be placed, the data sets can be used to perform page placement. After the page placement is finished, the page can be published, and thereby page access requests can be received.

If the placement task further includes update rule configuration information, the data retrieval may performed to re-determine data sets to be placed according to the placement conditions based on the update rule configuration information, and placement of service object information is performed for the corresponding resource locations in the page based on the re-determined data sets.

Details of implementations of each operation in the second embodiment can be referenced to the introduction in the first embodiment, and are not repeatedly described herein.

### Third Embodiment

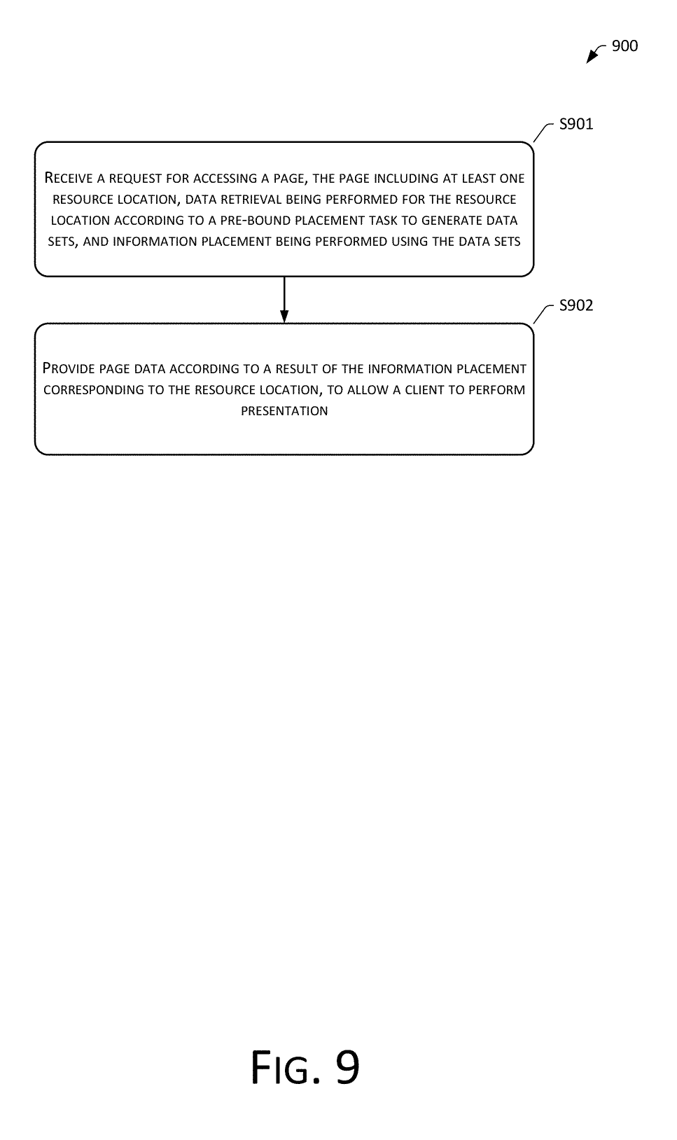

The third embodiment further provides a page access method. Referring to FIG. 9, the method 900 may include the following operations.

S901: Receive a request for accessing a page, the page including at least one resource location, each resource location including a plurality of unit display positions, each unit display position being used for displaying information of a service object, and a same resource location being used for displaying information of a plurality of service objects satisfying a same placement condition, wherein data retrieval is performed for the resource location according to a pre-bound placement task to generate data sets, and information placement is performed using the data sets.

Specifically, a page placement system performs page content placement according to a placement task that is bound to a specific page resource location, and may also update the placed content according to an update frequency and an update time point configured in the placement task. After the placement or update, the page is published, i.e., saved to a specific path of a specific server to generate a network access address, and thereby access requests of users can be received.

S902: Provide page data according to a result of the information placement corresponding to the resource location, to allow a client to perform presentation.

After the access request is received, page data can be provided according to a result of the information placement corresponding to the specific resource location in the page, so that presentation can be performed on a client.

Specific implementation details of page accesses are not described in detail herein.

### Fourth Embodiment

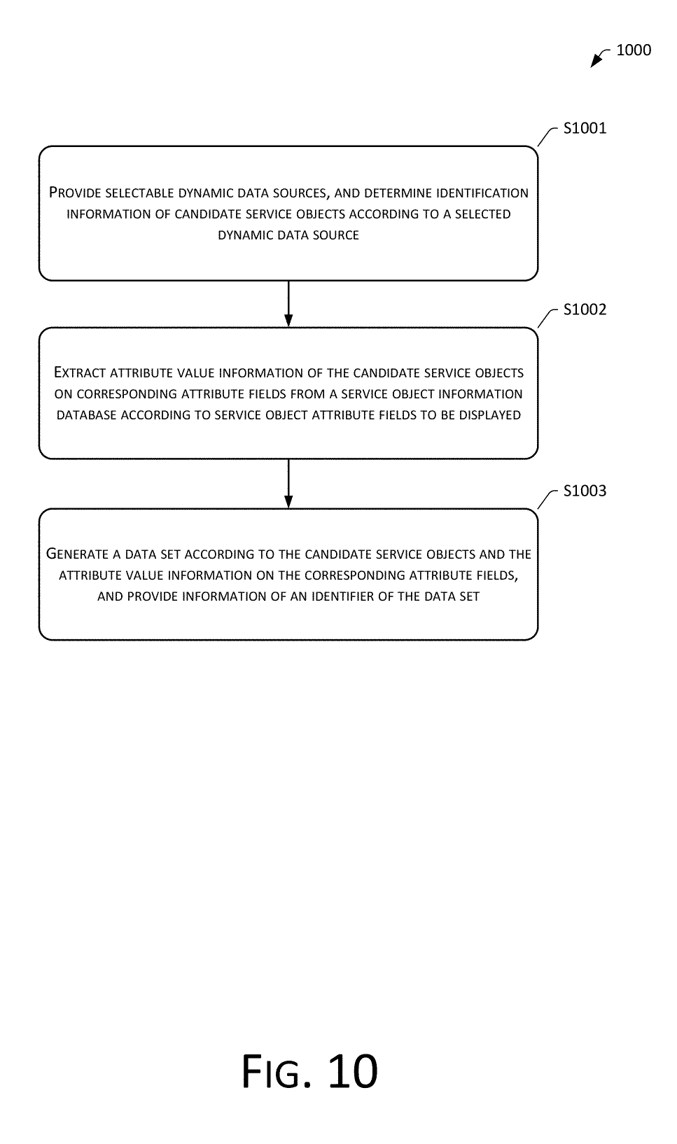

As described in the first embodiment, in order to further improve the efficiency of page content placement, and achieve reuse of data sets among different pages and different resource locations, the fourth embodiment of the present application further provides a method for creating a data set. Referring to FIG. 10, the method 1000 can include the following operations.

S1001: Provide selectable dynamic data sources, and determine identification information of candidate service objects according to a selected dynamic data source.

S1002: Extract attribute value information of the candidate service objects on corresponding attribute fields from a service object information database according to service object attribute fields to be displayed.

S1003: Generate a data set according to the candidate service objects and the attribute value information on the corresponding attribute fields, and provide information of an identifier of the data set, to allow using the data set identifier to specify a placement condition corresponding to a target resource location during a placement task of the target resource location in a target page.

Details of implementations of each operation in this embodiment can be referenced to the introduction in the foregoing first embodiment, and are not repeatedly described herein.

### Fifth Embodiment

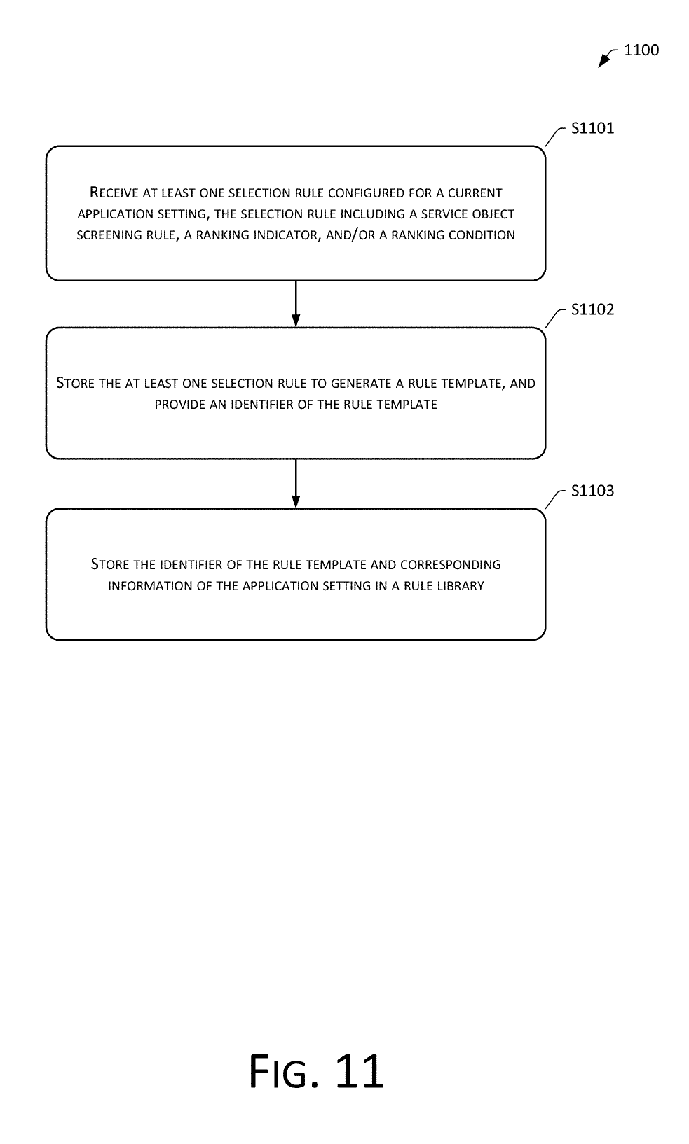

As described in the first embodiment, in order to further improve the efficiency of page content placement, a rule library may be provided, in which a plurality of rule templates are stored. A designer may select a rule template to configure selection rules without filling in configuration information of each item selection rule one by one. Specifically, referring to FIG. 11, the fifth embodiment provides a method for creating a rule library, and the method 1100 may include the following operations.

S1101: Receive at least one selection rule configured for a current application setting.

The selection rule may include a service object screening rule, a ranking indicator, and/or a ranking condition.

S1102: Store the at least one selection rule to generate a rule template, and provide an identifier of the rule template.

S1103: Store the identifier of the rule template and corresponding information of the application setting in a rule library, to allow provision of rule template information in the rule library and completion of configuration of selection rule(s) by selecting a rule template when a placement condition is configured for a target resource location of a target page.

Details of implementations of each operation in the fifth embodiment can be referenced to the introduction in the first embodiment, and are not repeatedly described herein.

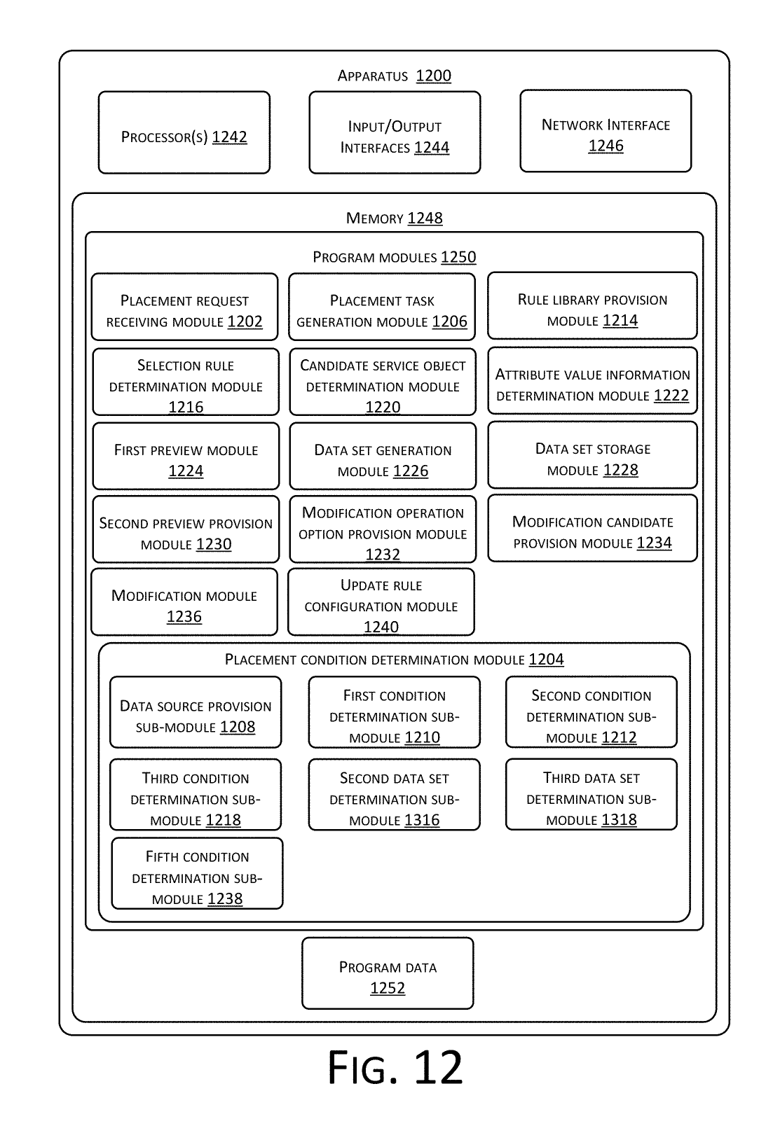

Corresponding to the first embodiment, the embodiments of the present application also provide a page resource placement apparatus 1200. In implementations, the apparatus 1200 may include one or more computing devices. In implementations, the apparatus 1200 may be a part of one or more computing devices, e.g., implemented or run by the one or more computing devices. In implementations, the one or more computing devices may be located in a single place or distributed among a plurality of network devices over a network. Referring to FIG. 12, the apparatus 1200 may include a placement request receiving module 1202 configured to receive a resource placement request, the placement request including resource location configuration information in a page, where the page includes at least one resource location, each resource location includes multiple unit display positions, each unit display position is used for displaying information of a service object, and a same resource location is used for displaying information of multiple service objects that satisfy a same placement condition; a placement condition determination module 1204 configured to determine placement condition(s) corresponding to the resource location; and a placement task generation module 1206 configured to generate a page resource placement task, the placement task being used for recording a binding relationship between the resource location in the page and the placement condition(s), to enable performing information placement for corresponding resource locations in the page according to the placement task.

The placement condition determination module 1204 includes a data source provision sub-module 1208 configured to provide selectable dynamic data sources; and a first condition determination sub-module 1210 configured to record a selection result of a dynamic data source and determine thereof as a first condition to help determining candidate service object(s) to be served according to the first condition.

In implementations, the placement condition determination module 1204 may also include a second condition determination sub-module 1212 configured to determine a selection rule and determine the selection rule as a second condition to allow a selection to be performed on the candidate service objects according to the second condition, wherein the selection rule includes the number of service objects, screening condition information, ranking information, and the like.

In order to facilitate configuration of a selection rule, the apparatus 1200 may further include a rule library provision module 1214 configured to provide a selection rule library, the selection rule library including at least one selection rule; and a selection rule determination module 1216 configured to determine a selection rule based on a selection result associated with the selection rule.

The resource location configuration information further includes content display style information in each unit display position, the content display style information including an attribute field of a service object to be displayed.

The placement condition determination module 1204 further includes a third condition determination sub-module 1218 configured to determine attribute field(s) of a service object to be displayed in each unit display position in the resource location as a third condition based the resource location configuration information, to allow determination of data content of each service object to be displayed based on the third condition.

Furthermore, the apparatus 1200 may also include a candidate service object determination module 1220 configured to determine candidate service objects according to a first condition; an attribute value information determination module 1222 configured to extract attribute value information of the candidate service objects on corresponding attribute fields from a service object information database according to the third condition; and a first preview module 1224 configured to provide a preview of the attribute value information of the candidate service objects on the corresponding attribute fields.

To implement reuse of data, the apparatus 1200 may further include a data set generation module 1226 configured to generate a data set according to attribute values of the candidate service objects on the corresponding attribute fields; and a data set storage module 1228 configured to store the data set and provide an identifier of the data set to allow provision of selectable identifiers of data sets in response to receiving a new placement request, the identifier of data set being determined as a fourth condition to help determining the data set based on the fourth condition.

In order to facilitate modification of an attribute field to meet requirements of more application settings, the apparatus 1200 may further include a second preview provision module 1230 configured to provide preview information of the data set determined by the fourth condition; a modification operation option provision module 1232 configured to provide an operation option for modifying an attribute field of a service object to be displayed; a modification candidate provision module 1234 configured to separately provide other selectable attribute fields for each attribute field in response to receiving a modification request through the operation option; and a modification module 1236 configured to re-obtain a corresponding attribute value according to a modified attribute field, and update configuration information of a corresponding data set if information of confirming a modification is received.

The placement request receiving module 1202 is specifically configured to receive a placement request of a client of a first user to perform resource placement to a specified store related page, and the data source provision module is specifically configured to provide a dynamic data source related to the first user.

In another implementation, the dynamic data source includes a service object statistical information data source.

In addition, the placement condition determination module 1204 may further include a fifth condition determination sub-module 1238 configured to determine starting and ending time configuration information of the placement, and determine the starting and ending time configuration information as the fifth condition, to allow determination of a state of the placement task according to the fifth condition, and to perform a corresponding placement task according to the state.

The apparatus 1200 may further include an update rule configuration module 1240 configured to determine update rule configuration information of the resource location, and record the update rule configuration information into the placement task, to allow an update of information placed in the resource location according to the update rule configuration information.

In implementations, the apparatus 1200 may further include one or more processors 1242, an input/output (I/O) interface 1244, a network interface 1246, and memory 1248.

The memory 1248 may include a form of computer readable media such as a volatile memory, a random access memory (RAM) and/or a non-volatile memory, for example, a read-only memory (ROM) or a flash RAM. The memory 1248 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1248 may include program modules 1250 and program data 1252. The program modules 1250 may include one or more of the foregoing modules and sub-modules as described in the foregoing description and FIG. 12.

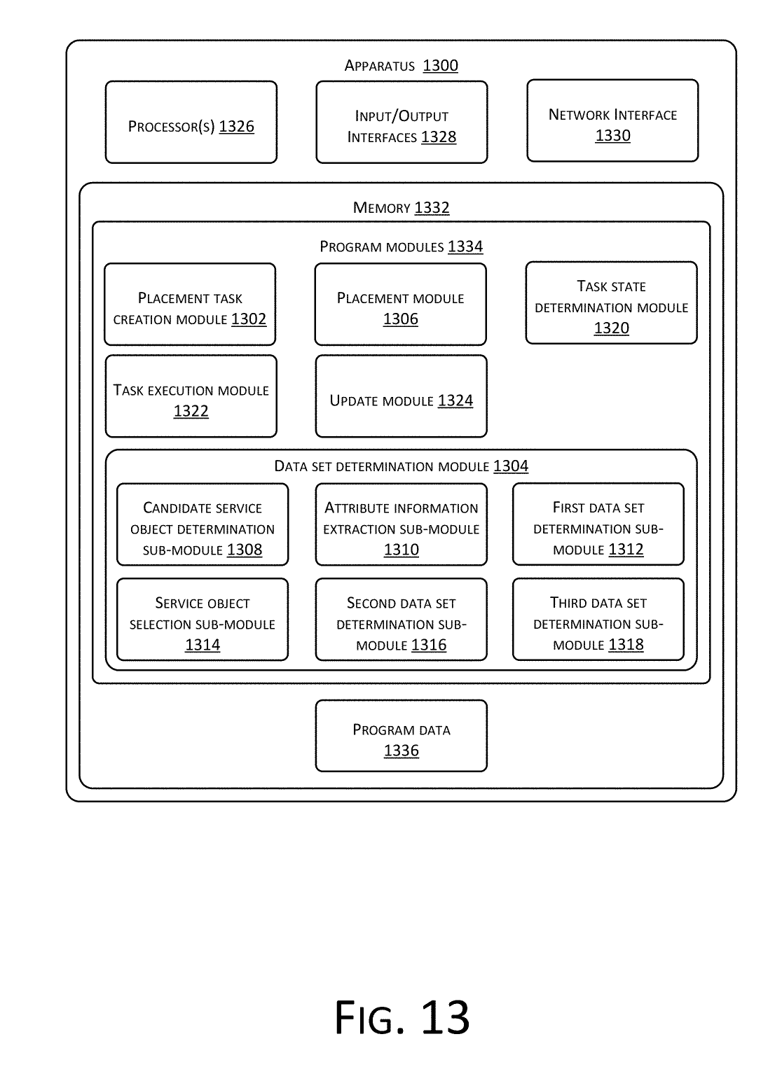

Corresponding to the second embodiment, the embodiments of the present application further provide a page resource placement apparatus 1300. In implementations, the apparatus 1300 may include one or more computing devices. In implementations, the apparatus 1300 may be a part of one or more computing devices, e.g., implemented or run by the one or more computing devices. In implementations, the one or more computing devices may be located in a single place or distributed among a plurality of network devices over a network. Referring to FIG. 13, the apparatus 1300 may include a placement task creation module 1302 configured to create a page resource placement task, the placement task being used for recording a binding relationship between resource locations and placement conditions in a page, where the page includes at least one resource location, each resource location includes a plurality of unit display positions, each unit display position is used for presenting information of a service object, and a same resource location is used for presenting information of multiple service objects that satisfy a same placement condition; a data set determination module 1304 configured to perform data retrieval according to the placement conditions, and determine data sets to be placed; and a placement module 1306 configured to perform placement of service object information to corresponding resource locations in the page according to the data sets to be placed.

The placement conditions include a first condition, and target dynamic data source information is recorded in the first condition. The data set determination module 1304 includes a candidate service object determination sub-module 1308 configured to determine identification information of candidate service objects based on the target dynamic data source information recorded in the first condition; an attribute information extraction sub-module 1310 configured to extract attribute information of the candidate service objects from a service object information database based on the identification information of the candidate service objects; and a first data set determination sub-module 1312 configured to determine data sets to be placed based on the attribute information of the candidate service objects.

Alternatively, the placement conditions further includes a second condition and selection rule information is recorded in the second condition. The data set determination module 1304 further includes a service object selection sub-module 1314 configured to select the candidate service objects according to the second condition, and a second data set determination sub-module 1316 configured to determine the data sets to be placed based on a result of selection.

Additionally, the placement conditions further includes a third condition and an attribute field of a service object to be displayed in each unit display position in the resource location is recorded in the third condition. The attribute information extraction sub-module 1310 is specifically configured to extract attributes of the candidate service objects on corresponding attribute fields from the service object information database according to the third condition.

The placement conditions include a fourth condition and a data set identifier is recorded in the fourth condition. The data set determination module 1304 includes a third data set determination sub-module 1318 configured to determine a data set to be placed according to the data set identifier in the fourth condition.

The placement conditions further include a fifth condition and the fifth condition records placement starting and ending time information. The apparatus 1300 further includes a task state determination module 1320 configured to determine a state of the placement task according to the fifth condition; and a task execution module 1322 configured to perform the corresponding placement task according to the state.

The placement task further includes update rule configuration information, and the apparatus 1300 further includes an update module 1324 configured to perform a data retrieval to re-determine data sets to be placed according to the placement conditions based on the update rule configuration information, and perform placement of service object information for the corresponding resource locations in the page based on the re-determined data sets.

In implementations, the apparatus 1300 may further include one or more processors 1326, an input/output (I/O) interface 1328, a network interface 1330, and memory 1332.

The memory 1332 may include a form of computer readable media. For example, the memory 1332 is an example of a computer readable media. In implementations, the memory 1332 may include program modules 1334 and program data 1336. The program modules 1334 may include one or more of the foregoing modules and sub-modules as described in the foregoing description and FIG. 13.

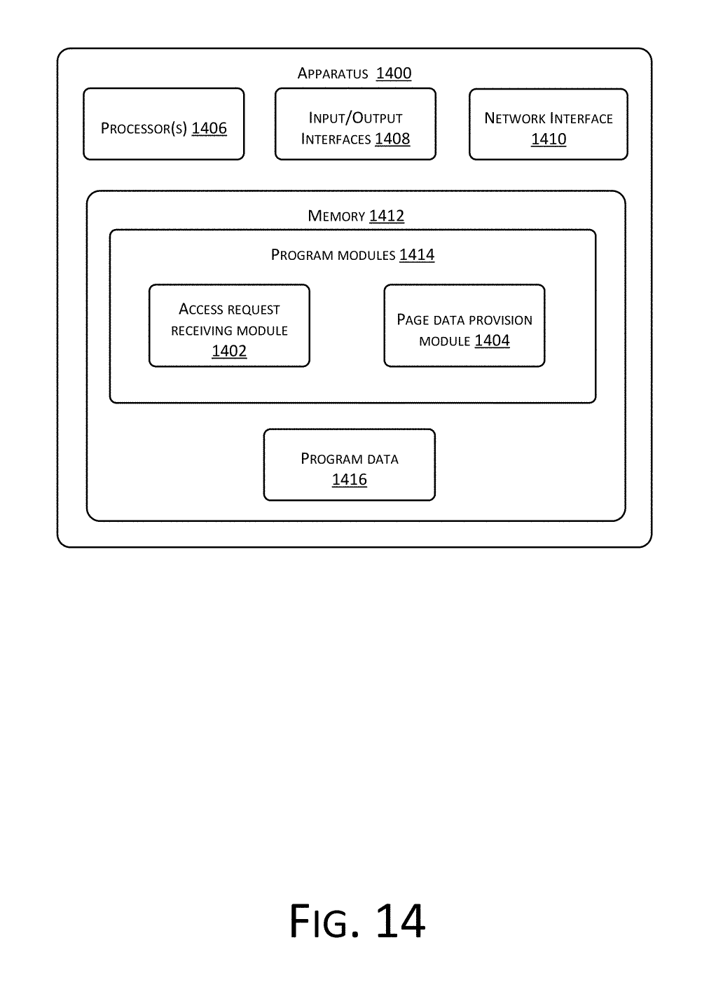

Corresponding to the third embodiment, the embodiments of the present application also provide a page resource placement apparatus 1400. In implementations, the apparatus 1400 may include one or more computing devices. In implementations, the apparatus 1400 may be a part of one or more computing devices, e.g., implemented or run by the one or more computing devices. In implementations, the one or more computing devices may be located in a single place or distributed among a plurality of network devices over a network. Referring to FIG. 14, the apparatus 1400 may include an access request receiving module 1402 configured to receive a request for accessing a page, the page including at least one resource location, each resource location including a plurality of unit display positions, each unit display position being used for displaying information of a service object, and a same resource location being used for displaying information of a plurality of service objects satisfying a same placement condition, wherein data retrieval is performed for the resource location according to a pre-bound placement task to generate data sets, and information placement is performed using the data sets; and a page data provision module 1404 configured to provide page data according to a result of the information placement corresponding to the resource location, to allow a client to perform presentation.

In implementations, the apparatus 1400 may further include one or more processors 1406, an input/output (I/O) interface 1408, a network interface 1410, and memory 1412.

The memory 1412 may include a form of computer readable media. For example, the memory 1412 is an example of a computer readable media. In implementations, the memory 1412 may include program modules 1414 and program data 1416. The program modules 1414 may include one or more of the foregoing modules and sub-modules as described in the foregoing description and FIG. 14.

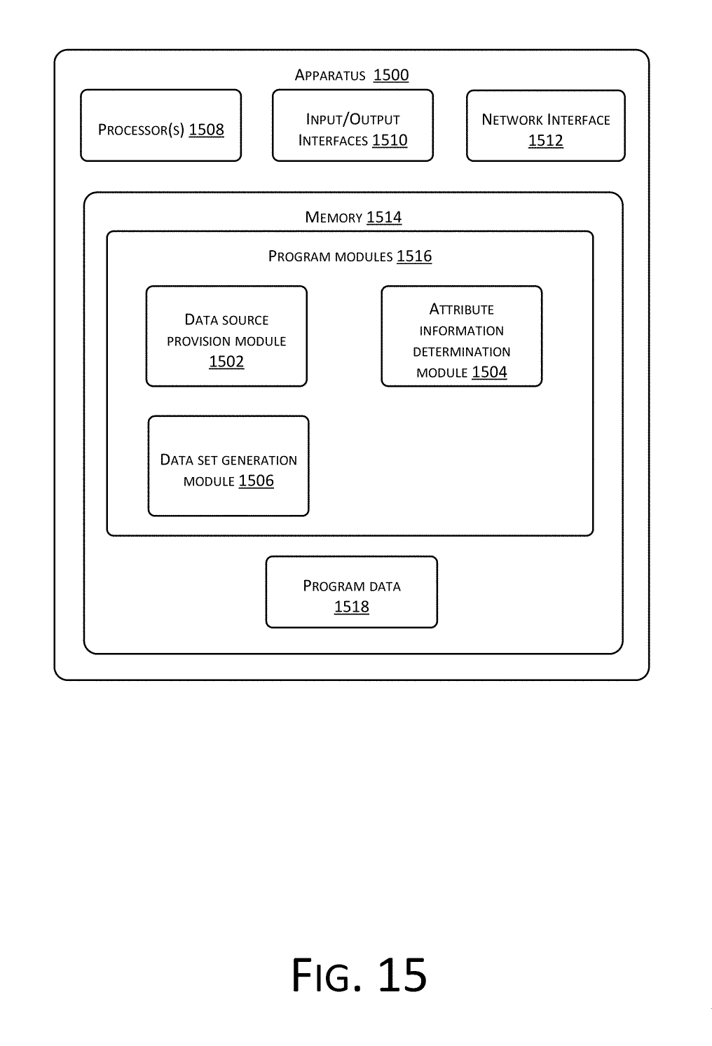

Corresponding to the fourth embodiment, the embodiments of the present application also provide a data set creation apparatus 1500. In implementations, the apparatus 1500 may include one or more computing devices. In implementations, the apparatus 1500 may be a part of one or more computing devices, e.g., implemented or run by the one or more computing devices. In implementations, the one or more computing devices may be located in a single place or distributed among a plurality of network devices over a network. Referring to FIG. 15, the apparatus 1500 may include a data source provision module 1502 configured to provide selectable dynamic data sources, and determine identification information of candidate service objects according to a selected dynamic data source; an attribute information determination module 1504 configured to extract attribute value information of the candidate service objects on corresponding attribute fields from a service object information database according to service object attribute fields to be displayed; and a data set generation module 1506 configured to generate a data set according to the candidate service objects and the attribute value information on the corresponding attribute fields, and provide information of an identifier of the data set, to allow using the data set identifier to specify a placement condition corresponding to a target resource location during a placement task of the target resource location in a target page.

In implementations, the apparatus 1500 may further include one or more processors 1508, an input/output (I/O) interface 1510, a network interface 1512, and memory 1514.

The memory 1514 may include a form of computer readable media. For example, the memory 1514 is an example of a computer readable media. In implementations, the memory 1514 may include program modules 1516 and program data 1518. The program modules 1516 may include one or more of the foregoing modules and sub-modules as described in the foregoing description and FIG. 15.

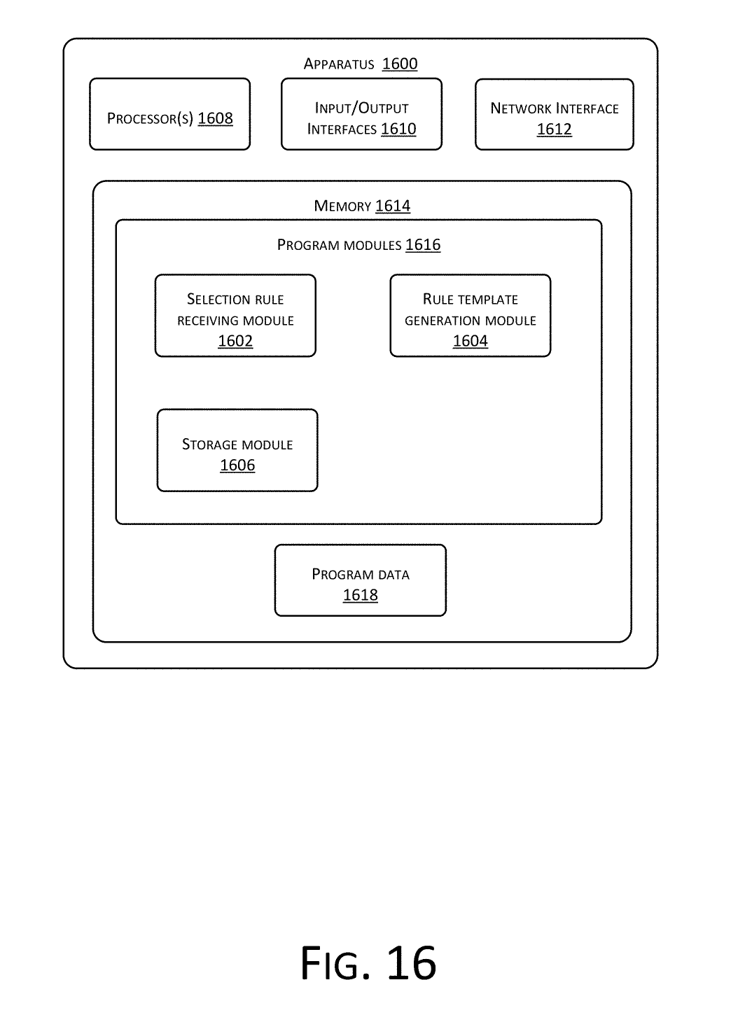

Corresponding to the fifth embodiment, the embodiments of the present application also provide a rule library creation apparatus 1600. In implementations, the apparatus 1600 may include one or more computing devices. In implementations, the apparatus 1600 may be a part of one or more computing devices, e.g., implemented or run by the one or more computing devices. In implementations, the one or more computing devices may be located in a single place or distributed among a plurality of network devices over a network. Referring to FIG. 16, the apparatus 1600 may include a selection rule receiving module 1602 configured to receive at least one selection rule configured for a current application setting, The selection rule including a service object screening rule, a ranking indicator, and/or a ranking condition; a rule template generation module 1604 configured to store the at least one selection rule to generate a rule template, and provide an identifier of the rule template; and a storage module 1606 configured to store the identifier of the rule template and corresponding information of the application setting in a rule library, to allow provision of rule template information in the rule library and completion of configuration of selection rule(s) by selecting a rule template when a placement condition is configured for a target resource location of a target page.

In implementations, the apparatus 1600 may further include one or more processors 1608, an input/output (I/O) interface 1610, a network interface 1612, and memory 1614.

The memory 1614 may include a form of computer readable media. For example, the memory 1614 is an example of a computer readable media. In implementations, the memory 1614 may include program modules 1616 and program data 1618. The program modules 1616 may include one or more of the foregoing modules and sub-modules as described in the foregoing description and FIG. 16.

As can be seen from the description of the above embodiments, one skilled in the art can clearly understand that the present application can be implemented by means of software with a necessary universal hardware platform. Based on this understanding, the essence of the technical solutions of the present application or the part contributing to existing technologies may be embodied in a form of a software product. Such computer software product may be stored in a storage media, such as a ROM/RAM, a magnetic disk, an optical disk, etc., and includes instructions to cause a computing device (which may be a personal computer, a mobile terminal, a server, or a network device, etc.) to execute the methods described in various embodiments or certain parts of the embodiments of the present application.

Various embodiments in the present specification are described in a progressive manner, and the same or similar parts among the various embodiments may be referenced to each other. Each embodiment focuses on an aspect that is different from those of other embodiments. In particular, due to their substantially similarities to the method embodiments, the description of the systems or systems embodiments is relatively simple, and relevant parts can be referred to respective portions of the method embodiments. The systems and system embodiments described above are merely illustrative. Units that are described as separate components may or may not be physically separate. Components displayed as units may or may not be physical units, i.e., can be located in one place or can be distributed among multiple network units. Some or all of the modules may be selected according to actual needs to achieve the purpose of the solutions of the embodiments. One of ordinary skill in the art can understand and implement without making any creative effort.

The methods and apparatuses for placing page resources provided by the present application are described in detail above. The principles and implementations of the present application are described using specific examples in the text. The description of the above embodiments is only used to help understand the methods of the present application and its core ideas. At the same time, for one of ordinary skill in the art, changes exist in specific implementations and scopes of application based on the ideas of the present application. In summary, the content of the present specification should not be construed as limiting the present application.

The present application can be further understood using the following clauses.

Clause 1: A page resource placement method comprising: receiving a resource placement request, the placement request including resource location configuration information in a page, wherein the page includes at least one resource location, each resource location includes multiple unit display positions, each unit display position is used for displaying information of a service object, and a same resource location is used for displaying information of multiple service objects that satisfy a same placement condition; determining placement conditions corresponding to the resource location; and generating a page resource placement task, the placement task being used for recording a binding relationship between the resource location in the page and the placement conditions, to enable performing information placement for corresponding resource locations in the page according to the placement task.

Clause 2: The method of Clause 1, wherein determining the placement conditions corresponding to the resource location comprises: providing selectable dynamic data sources; and recording a selection result of a dynamic data source and determine thereof as a first condition to help determining candidate service objects to be served according to the first condition.

Clause 3: The method of Clause 2, wherein determining the placement conditions corresponding to the resource location further comprises determining a selection rule and determining the selection rule as a second condition to allow a selection to be performed on the candidate service objects according to the second condition.

Clause 4: The method of Clause 3, wherein the selection rule comprises the number of service objects, screening condition information, and/or ranking information.

Clause 5: The method of Clause 4, further comprising: providing a selection rule library, the selection rule library including at least one selection rule; and determining a selection rule based on a selection result associated with the selection rule.

Clause 6: The method of Clause 2 or 3, wherein the resource location configuration information further comprises content display style information in each unit display position, the content display style information comprising an attribute field of a service object to be displayed, and determining the placement conditions corresponding to the resource location further comprises determining an attribute field of a service object to be displayed in each unit display position in the resource location as a third condition based the resource location configuration information, to allow determination of data content of each service object to be displayed based on the third condition.

Clause 7: The method of Clause 6, further comprising: determining candidate service objects according to a first condition; extracting attribute value information of the candidate service objects on corresponding attribute fields from a service object information database according to the third condition; and providing a preview of the attribute value information of the candidate service objects on the corresponding attribute fields.

Clause 8: The method of Clause 7, further comprising: generating a data set according to attribute values of the candidate service objects on the corresponding attribute fields; and storing the data set and provide an identifier of the data set to allow provision of selectable identifiers of data sets in response to receiving a new placement request, the identifier of data set being determined as a fourth condition to help determining the data set based on the fourth condition.

Clause 9: The method of Clause 8, further comprising: providing preview information of the data set determined by the fourth condition; providing an operation option for modifying an attribute field of a service object to be displayed; separately providing other selectable attribute fields for each attribute field in response to receiving a modification request through the operation option; and re-obtaining a corresponding attribute value according to a modified attribute field, and updating configuration information of a corresponding data set if information of confirming a modification is received.

Clause 10: The method of Clause 2, wherein receiving the resource placement request comprises receiving a placement request of a client of a first user to perform resource placement to a specified store related page, and providing the selectable dynamic data sources comprises providing a dynamic data source related to the first user.

Clause 11: The method of Clause 2, wherein the dynamic data source comprises a service object statistical information data source.

Clause 12: The method of any one of Clauses 1-11, wherein determining the placement conditions corresponding to the resource location comprises determining starting and ending time configuration information of the placement, and determining the starting and ending time configuration information as the fifth condition, to allow determination of a state of the placement task according to the fifth condition, and to perform a corresponding placement task according to the state.

Clause 13: The method of any one of Clauses 1-11, further comprising determining update rule configuration information of the resource location, and recording the update rule configuration information into the placement task, to allow an update of information placed in the resource location according to the update rule configuration information.

Clause 14: A page resource placement method comprising: creating a page resource placement task, the placement task being used for recording a binding relationship between resource locations and placement conditions in a page, wherein the page includes at least one resource location, each resource location includes a plurality of unit display positions, each unit display position is used for presenting information of a service object, and a same resource location is used for presenting information of multiple service objects that satisfy a same placement condition; performing data retrieval according to the placement conditions, and determining data sets to be placed; and performing placement of service object information to corresponding resource locations in the page according to the data sets to be placed.

Clause 15: The method of Clause 14, wherein the placement conditions comprise a first condition, target dynamic data source information being recorded in the first condition, and performing the data retrieval according to the placement conditions, and determining data sets to be placed comprise: determining identification information of candidate service objects based on the target dynamic data source information recorded in the first condition; extracting attribute information of the candidate service objects from a service object information database based on the identification information of the candidate service objects; and determining data sets to be placed based on the attribute information of the candidate service objects.

Clause 16: The method of Clause 15, wherein the placement conditions further comprise a second condition, selection rule information being recorded in the second condition, and performing the data retrieval according to the placement conditions, and determining data sets to be placed comprise: selecting the candidate service objects according to the second condition, and determining the data sets to be placed based on a result of selection.

Clause 17: The method of Clause 15 or 16, wherein the placement conditions further comprise a third condition, an attribute field of a service object to be displayed in each unit display position in the resource location being recorded in the third condition, and extracting the attribute information of the candidate service objects from the service object information database comprises extracting attributes of the candidate service objects on corresponding attribute fields from the service object information database according to the third condition.

Clause 18: The method of Clause 14, wherein the placement conditions comprise a fourth condition, a data set being is recorded in the fourth condition, and performing the data retrieval according to the placement conditions, and determining data sets to be placed comprise determining a data set to be placed according to the data set identifier in the fourth condition.

Clause 19: The method of Clause 14, wherein the placement conditions further comprise a fifth condition, the fifth condition recording placement starting and ending time information, and the method further comprises: determining a state of the placement task according to the fifth condition; and performing the corresponding placement task according to the state.

Clause 20: The method of Clause 14, wherein the placement task further comprises update rule configuration information, and the method further comprises performing a data retrieval to re-determine data sets to be placed according to the placement conditions based on the update rule configuration information, and performing placement of service object information for the corresponding resource locations in the page based on the re-determined data sets.

Clause 21: A page resource placement method comprising: receiving a request for accessing a page, the page including at least one resource location, each resource location including a plurality of unit display positions, each unit display position being used for displaying information of a service object, and a same resource location being used for displaying information of a plurality of service objects satisfying a same placement condition, wherein data retrieval is performed for the resource location according to a pre-bound placement task to generate data sets, and information placement is performed using the data sets; and providing page data according to a result of the information placement corresponding to the resource location, to allow a client to perform presentation.

Clause 22: A method for creating a data set comprising: providing selectable dynamic data sources, and determine identification information of candidate service objects according to a selected dynamic data source; extracting attribute value information of the candidate service objects on corresponding attribute fields from a service object information database according to service object attribute fields to be displayed; and generating a data set according to the candidate service objects and the attribute value information on the corresponding attribute fields, and provide information of an identifier of the data set, to allow using the data set identifier to specify a placement condition corresponding to a target resource location during a placement task of the target resource location in a target page.

Clause 23: A rule library creation method comprising: receiving at least one selection rule configured for a current application setting, The selection rule including a service object screening rule, a ranking indicator, and/or a ranking condition; storing the at least one selection rule to generate a rule template, and provide an identifier of the rule template; and storing the identifier of the rule template and corresponding information of the application setting in a rule library, to allow provision of rule template information in the rule library and completion of configuration of selection rule(s) by selecting a rule template when a placement condition is configured for a target resource location of a target page.

Clause 24: A page resource placement apparatus comprising: a placement request receiving module configured to receive a resource placement request, the placement request including resource location configuration information in a page, wherein the page includes at least one resource location, each resource location includes multiple unit display positions, each unit display position is used for displaying information of a service object, and a same resource location is used for displaying information of multiple service objects that satisfy a same placement condition; a placement condition determination module configured to determine placement condition(s) corresponding to the resource location; and a placement task generation module configured to generate a page resource placement task, the placement task being used for recording a binding relationship between the resource location in the page and the placement condition(s), to enable performing information placement for corresponding resource locations in the page according to the placement task.

Clause 25: The apparatus of Clause 24, wherein the placement condition determination module comprises: a data source provision sub-module configured to provide selectable dynamic data sources; and a first condition determination sub-module configured to record a selection result of a dynamic data source and determine thereof as a first condition to help determining candidate service object(s) to be served according to the first condition.

Clause 26: The apparatus of Clause 25, wherein the placement condition determination module further comprises a second condition determination sub-module configured to determine a selection rule and determine the selection rule as a second condition to allow a selection to be performed on the candidate service objects according to the second condition.

Clause 27: The apparatus of Clause 25 or 26, wherein the resource location configuration information further comprises content display style information in each unit display position, the content display style information including an attribute field of a service object to be displayed, and the placement condition determination module further comprises a third condition determination sub-module configured to determine attribute field(s) of a service object to be displayed in each unit display position in the resource location as a third condition based the resource location configuration information, to allow determination of data content of each service object to be displayed based on the third condition.

Clause 28: The apparatus of Clause 27, further comprising: a data set generation module configured to generate a data set according to attribute values of the candidate service objects on the corresponding attribute fields; and a data set storage module configured to store the data set and provide an identifier of the data set to allow provision of selectable identifiers of data sets in response to receiving a new placement request, the identifier of data set being determined as a fourth condition to help determining the data set based on the fourth condition.

Clause 29: The apparatus of any one of Clauses 24-28, wherein the placement condition determination module further comprises a fifth condition determination sub-module configured to determine starting and ending time configuration information of the placement, and determine the starting and ending time configuration information as the fifth condition, to allow determination of a state of the placement task according to the fifth condition, and to perform a corresponding placement task according to the state.

Clause 30: The apparatus of any one of Clauses 24-28, further comprising an update rule configuration module configured to determine update rule configuration information of the resource location, and record the update rule configuration information into the placement task, to allow an update of information placed in the resource location according to the update rule configuration information.

Clause 31: A page resource placement apparatus comprising: a placement task creation module configured to create a page resource placement task, the placement task being used for recording a binding relationship between resource locations and placement conditions in a page, wherein the page includes at least one resource location, each resource location includes a plurality of unit display positions, each unit display position is used for presenting information of a service object, and a same resource location is used for presenting information of multiple service objects that satisfy a same placement condition; a data set determination module configured to perform data retrieval according to the placement conditions, and determine data sets to be placed; and a placement module configured to perform placement of service object information to corresponding resource locations in the page according to the data sets to be placed.

Clause 32: A page resource placement apparatus comprising: an access request receiving module configured to receive a request for accessing a page, the page including at least one resource location, each resource location including a plurality of unit display positions, each unit display position being used for displaying information of a service object, and a same resource location being used for displaying information of a plurality of service objects satisfying a same placement condition, wherein data retrieval is performed for the resource location according to a pre-bound placement task to generate data sets, and information placement is performed using the data sets; and a page data provision module configured to provide page data according to a result of the information placement corresponding to the resource location, to allow a client to perform presentation.

Clause 33: A data set creation apparatus comprising: a data source provision module configured to provide selectable dynamic data sources, and determine identification information of candidate service objects according to a selected dynamic data source; an attribute information determination module configured to extract attribute value information of the candidate service objects on corresponding attribute fields from a service object information database according to service object attribute fields to be displayed; and a data set generation module configured to generate a data set according to the candidate service objects and the attribute value information on the corresponding attribute fields, and provide information of an identifier of the data set, to allow using the data set identifier to specify a placement condition corresponding to a target resource location during a placement task of the target resource location in a target page.

Clause 34: A rule library creation apparatus comprising: a selection rule receiving module configured to receive at least one selection rule configured for a current application setting, The selection rule including a service object screening rule, a ranking indicator, and/or a ranking condition; a rule template generation module configured to store the at least one selection rule to generate a rule template, and provide an identifier of the rule template; and a storage module configured to store the identifier of the rule template and corresponding information of the application setting in a rule library, to allow provision of rule template information in the rule library and completion of configuration of selection rule(s) by selecting a rule template when a placement condition is configured for a target resource location of a target page.

What is claimed is:

1. A method comprising:
receiving a resource placement request, the placement request including resource location configuration information in a page, wherein the page includes at least one resource location, each resource location includes multiple unit display positions, each unit display position is used for displaying information of a service object, and a same resource location is used for displaying information of multiple service objects that satisfy a same placement condition;
determining placement conditions corresponding to the resource location; and
generating a page resource placement task, the placement task being used for recording a binding relationship between the resource location in the page and the placement conditions, to enable performing information placement for corresponding resource locations in the page according to the placement task.

2. The method of claim 1, wherein determining the placement conditions corresponding to the resource location comprises:
providing selectable dynamic data sources; and
recording a selection result of a dynamic data source and determine thereof as a first condition to help determining candidate service objects to be served according to the first condition.

3. The method of claim 2, wherein determining the placement conditions corresponding to the resource location further comprises determining a selection rule and determining the selection rule as a second condition to allow a selection to be performed on the candidate service objects according to the second condition.

4. The method of claim 3, wherein the selection rule comprises the number of service objects, screening condition information, and/or ranking information.

5. The method of claim 4, further comprising:
providing a selection rule library, the selection rule library including at least one selection rule; and
determining a selection rule based on a selection result associated with the selection rule.

6. The method of claim 2, wherein the resource location configuration information further comprises content display style information in each unit display position, the content display style information comprising an attribute field of a service object to be displayed, and determining the placement conditions corresponding to the resource location further comprises determining an attribute field of a service object to be displayed in each unit display position in the resource location as a third condition based the resource location configuration information, to allow determination of data content of each service object to be displayed based on the third condition.

7. The method of claim 6, further comprising:
determining candidate service objects according to a first condition;
extracting attribute value information of the candidate service objects on corresponding attribute fields from a service object information database according to the third condition; and
providing a preview of the attribute value information of the candidate service objects on the corresponding attribute fields.

8. The method of claim 7, further comprising:
generating a data set according to attribute values of the candidate service objects on the corresponding attribute fields; and
storing the data set and provide an identifier of the data set to allow provision of selectable identifiers of data sets in response to receiving a new placement request, the identifier of data set being determined as a fourth condition to help determining the data set based on the fourth condition.

9. The method of claim 8, further comprising:
providing preview information of the data set determined by the fourth condition;
providing an operation option for modifying an attribute field of a service object to be displayed;
separately providing other selectable attribute fields for each attribute field in response to receiving a modification request through the operation option; and
re-obtaining a corresponding attribute value according to a modified attribute field, and updating configuration information of a corresponding data set if information of confirming a modification is received.

10. The method of claim 2, wherein receiving the resource placement request comprises receiving a placement request of a client of a first user to perform resource placement to a specified store related page, and providing the selectable dynamic data sources comprises providing a dynamic data source related to the first user.

11. The method of claim 2, wherein the dynamic data source comprises a service object statistical information data source.

12. The method of claim 1, wherein determining the placement conditions corresponding to the resource location comprises determining starting and ending time configuration information of the placement, and determining the starting and ending time configuration information as the fifth condition, to allow determination of a state of the placement task according to the fifth condition, and to perform a corresponding placement task according to the state.

13. The method of claim 1, further comprising determining update rule configuration information of the resource location, and recording the update rule configuration information into the placement task, to allow an update of information placed in the resource location according to the update rule configuration information.

14. One or more computer readable media storing executable instructions that, when executed by one or more processors, cause the one or more processors to perform acts comprising:
creating a page resource placement task, the placement task being used for recording a binding relationship between resource locations and placement conditions in a page, wherein the page includes at least one resource location, each resource location includes a plurality of unit display positions, each unit display position is used for presenting information of a service object, and a same resource location is used for presenting information of multiple service objects that satisfy a same placement condition;
performing data retrieval according to the placement conditions, and determining data sets to be placed; and
performing placement of service object information to corresponding resource locations in the page according to the data sets to be placed.

15. The one or more computer readable media of claim 14, wherein the placement conditions comprise a first condition, target dynamic data source information being recorded in the first condition, and performing the data retrieval according to the placement conditions, and determining data sets to be placed comprise:
determining identification information of candidate service objects based on the target dynamic data source information recorded in the first condition;
extracting attribute information of the candidate service objects from a service object information database based on the identification information of the candidate service objects; and
determining data sets to be placed based on the attribute information of the candidate service objects.

16. The one or more computer readable media of claim 15, wherein the placement conditions further comprise a second condition, selection rule information being recorded in the second condition, and performing the data retrieval according to the placement conditions, and determining data sets to be placed comprise:
selecting the candidate service objects according to the second condition, and
determining the data sets to be placed based on a result of selection.

17. The one or more computer readable media of claim 15, wherein the placement conditions further comprise a third condition, an attribute field of a service object to be displayed in each unit display position in the resource location being recorded in the third condition, and extracting the attribute information of the candidate service objects from the service object information database comprises extracting attributes of the candidate service objects on corresponding attribute fields from the service object information database according to the third condition.

18. The one or more computer readable media of claim 14, wherein the placement conditions comprise a fourth condition, a data set being is recorded in the fourth condition, and performing the data retrieval according to the placement conditions, and determining data sets to be placed comprise determining a data set to be placed according to the data set identifier in the fourth condition.

19. The one or more computer readable media of claim 14, wherein the placement conditions further comprise a fifth condition, the fifth condition recording placement starting and ending time information, and the acts further comprise:
determining a state of the placement task according to the fifth condition; and
performing the corresponding placement task according to the state.

20. A page resource placement apparatus comprising:
one or more processors;
memory;
an access request receiving module stored in the memory and executable by the one or more processors to receive a request for accessing a page, the page including at least one resource location, each resource location including a plurality of unit display positions, each unit display position being used for displaying information of a service object, and a same resource location being used for displaying information of a plurality of service objects satisfying a same placement condition, wherein data retrieval is performed for the resource location according to a pre-bound placement task to generate data sets, and information placement is performed using the data sets; and
a page data provision module stored in the memory and executable by the one or more processors to provide page data according to a result of the information placement corresponding to the resource location, to allow a client to perform presentation.
